(19) United States
(12) Patent Application Publication
(10) Pub. No.: US 2025/0240483 A1
(43) Pub. Date: Jul. 24, 2025

(54) INFORMATION PROCESSING DEVICE, DISPLAY SYSTEM, AND INFORMATION PROCESSING METHOD

(71) Applicant: Sharp NEC Display Solutions, Ltd., Tokyo (JP)

(72) Inventor: Eifu NEZU, Tokyo (JP)

(21) Appl. No.: 19/176,801

(22) Filed: Apr. 11, 2025

Related U.S. Application Data
(63) Continuation of application No. PCT/JP2022/037815, filed on Oct. 11, 2022.

(51) Int. Cl. H04N 21/442; H04N 21/4223

(52) U.S. Cl. CPC H04N 21/44218; H04N 21/4223; H04N 21/44204

(57) ABSTRACT

An information processing device includes a generation unit configured to generate a reproduction schedule that determines an order and/or the number of times according to a type of content to be reproduced, on the basis of a viewing status of a plurality of persons included in a captured image obtained by capturing an area where a display screen of a display device is visible.

### TECHNICAL FIELD

The present invention relates to an information processing device, a display system, and an information processing method.

### BACKGROUND ART

One method of sales promotion is to display product advertising content on a display device to advertise and promote to viewers.

Patent Document 1 describes a signage system that accumulates attribute tendency information of viewers who stop in front of a signage terminal and passersby passing in front of the signage terminal by linking it to a day of the week and time, and generates and reproduces a time schedule for content reproduction by arranging content data selected according to the attribute tendency information according to a statistical time. However, a technology described in Patent Document 1 does not necessarily make it possible to reproduce content that is appealing to a person actually viewing the digital signage.

It is possible to dynamically change the content to be reproduced according to attributes of a viewing person, but when a plurality of persons are viewing a digital signage, only content targeted at persons with specific attributes among the plurality of persons can be reproduced.

### CITATION LIST

### Patent Document

Patent Document 1: Japanese Unexamined Patent Application, First Publication No. 2014-014014

### SUMMARY OF INVENTION

### Technical Problem

The problem to be solved is that when a plurality of persons are viewing a display device, it is not possible to efficiently switch between target persons and effectively reproduce content.

### Solution to Problem

One aspect of the present invention is an information processing device including a generation unit configured to generate a reproduction schedule that determines an order and/or the number of times according to a type of content to be reproduced, on the basis of a viewing status of a plurality of persons included in a captured image obtained by capturing an area where a display screen of a display device is visible.

In addition, another aspect of the present invention is a display system including a generation unit configured to generate a reproduction schedule that determines an order and/or the number of times according to a type of content to be reproduced, on the basis of the viewing status of the plurality of persons included in the captured image obtained by capturing an area where a display screen of a display device is visible, and a display device configured to reproduce content on the basis of the reproduction schedule.

In addition, still another aspect of the present invention is an information processing method causing a computer to execute a generation step of generating a reproduction schedule that determines an order and/or the number of times according to a type of content to be reproduced, on the basis of the viewing status of the plurality of persons included in the captured image obtained by capturing an area where a display screen of a display device is visible.

### Advantageous Effects of Invention

According to the present invention, when a plurality of persons are viewing a display device, a target person can be efficiently switched to and content can be effectively displayed.

### BRIEF DESCRIPTION OF DRAWINGS

FIG. 1 A schematic diagram representing a configuration of a display system in an embodiment of the present invention.

FIG. 2 A schematic block diagram representing a functional configuration of an information processing device in the embodiment of the present invention.

FIG. 3 A diagram representing an example of a reproduction schedule generated on the basis of a score of each target person in the embodiment of the present invention.

FIG. 4 A flowchart which describes an operation of score calculation processing executed by the display system in the embodiment of the present invention.

FIG. 5 A flowchart representing an operation of reproduction schedule generation processing executed by the display system in the embodiment of the present invention.

FIG. 6 A diagram representing a configuration example of another aspect of the information processing device of the present invention.

### DESCRIPTION OF EMBODIMENTS

Hereinafter, an embodiment of the present invention will be described.

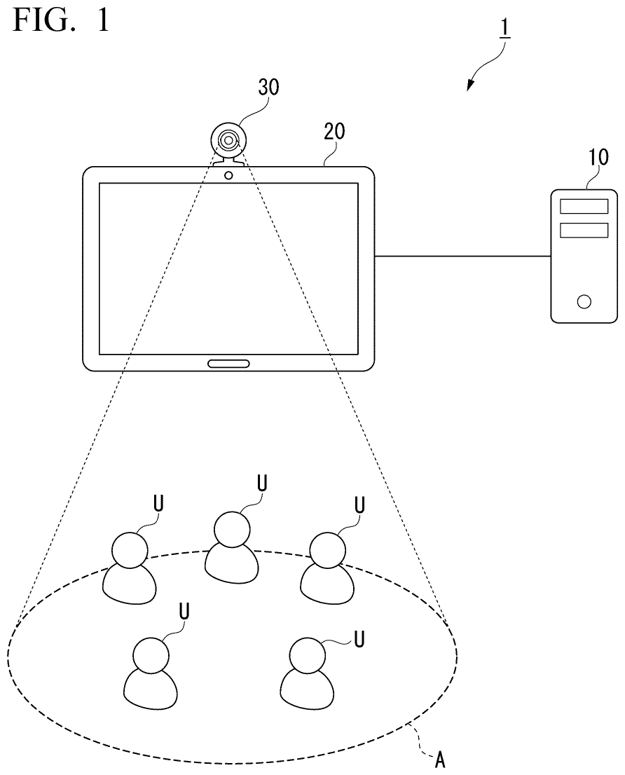

FIG. 1 is a schematic diagram which shows a configuration of a display system according to an embodiment of the present invention. In this embodiment, a display system 1 is a system that controls a display of content displayed on an electronic sign such as a digital signage. The content is for advertising purposes and may be a still image or a moving image, and may or may not have sound.

In FIG. 1, the display system 1 has an information processing device 10, a display device 20, and an imaging device 30. The information processing device 10 and the imaging device 30 are connected for communication via a wired or wireless local area network (LAN) or serial communication. The information processing device 10 and the display device 20 are also connected via a video cable that transmits video signals.

The information processing device 10 is a computer that controls a display of the display device 20. For example, the information processing device 10 outputs a video signal of the content to the display device 20, causing the display device 20 to display the content.

The display device 20 is a digital signage that displays advertising content on its display screen. The display device 20 is installed in public places where an unspecified number of people gather, such as train stations and shopping malls.

The imaging device 30 is installed near the display device 20, and captures an image of an imaging area A near the display device 20. The imaging area A is, for example, in front of a display screen of the display device 20, and is an area in which the display screen of the display device 20 is visible. The imaging device 30 generates a captured image by capturing the image of the imaging area A, and transmits the generated image to the information processing device 10. The imaging device 30 may be embedded in the display device 20, or may be an external device installed outside the display device 20.

In this embodiment, the information processing device 10, the display device 20, and the imaging device 30 are described as separate devices, but the present invention is not limited thereto, and the display device 20 may have each function of the information processing device 10 or the imaging device 30.

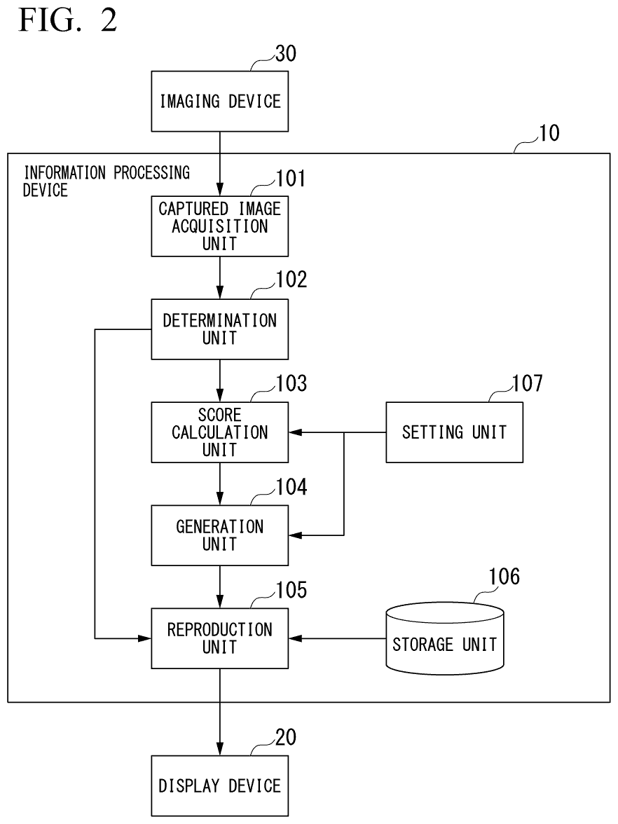

FIG. 2 is a schematic block diagram which shows a functional configuration of the information processing device in the embodiment of the present invention.

The information processing device 10 has a captured image acquisition unit 101, a determination unit 102, a score calculation unit 103, a generation unit 104, a reproduction unit 105, a storage unit 106, and a setting unit 107.

The captured image acquisition unit 101 acquires a captured image of the imaging area A by receiving it from the imaging device 30.

The determination unit 102 determines whether conditions for generating a reproduction schedule of content which will be described below are satisfied on the basis of the acquired captured image. Specifically, the determination unit 102 determines that the conditions for generating a reproduction schedule are satisfied when a plurality of persons U remain within a viewing range where the display screen of the display device can be reliably viewed (for example, within 1 to 3 meters from the display screen when a size of the display screen is 50 inches) for a certain period of time (for example, seconds to 2 minutes) or more (hereinafter referred to as a “retention state”). For example, the determination unit 102 determines that a plurality of persons have remained within the viewing range for a certain period of time or more when a plurality of persons are detected from the captured image and a position of each detected person does not change for a certain period of time, or when a moving distance of each detected person within the certain period of time is within a reference value. When the moving distance is within the reference value, for example, when the moving distance is within several tens of centimeters, it may be regarded as no change in the position. For example, when a person continues to stand for a certain period of time, since he or she may change his or her posture slightly, in such a case, a position of the person may be considered as not changed.

When the conditions for generating a reproduction schedule are satisfied (retention state), the score calculation unit 103 calculates the scores of each of the plurality of persons on the basis of the viewing status of each person within the viewing range at a predetermined period (for example, 1 second). The viewing status is at least one of a distance from the display device 20 to a person, a position of the person relative to the display device 20, and time during which the person is viewing the display screen. The score calculated by the score calculation unit 103 indicates a degree of interest in the display device 20 based on the viewing status of each person. In the present embodiment, the degree of interest becomes higher as the score increases, and the degree of interest becomes lower as the score decreases. Specifically, the score calculation unit 103 first detects a person who remains within the viewing range for a certain period of time or more, and analyzes the attributes (for example, age and sex) of each detected person. The score calculation unit 103 may analyze the attributes based on a face image of the person, or may analyze the attributes based on clothing of the person, or the like.

Next, the score calculation unit 103 assigns a score to each of the detected persons. Specifically, the score calculation unit 103 assigns a score to each of items of the distance from the display device 20 to a person, the position of the person relative to the display device 20, and the time during which the person is viewing the display screen, and calculates the total score. For example, the score calculation unit 103 assigns a higher score to a person who is closer to the display device 20, and assigns a lower score to a person who is farther away from the display device (for example, 10 points for a case where the distance from the display device 20 is 1 m, 3 points for a case where the distance from the display device 20 is 3 m, and the like). The score calculation unit 103 also assigns a higher score to a person whose position is closer to a center of the display screen relative to the display device 20, and assigns a lower score to a person whose position is farther away from the center (for example, 10 points for the position in the center, 3 points for the positions at both ends, and the like). The score calculation unit 103 assigns a higher score to a person who is viewing the display device 20 for a longer period of time, and assigns a lower score to a person who is viewing the display device for a shorter period of time (for example, 10 points for a case where the viewing time is 2 minutes or more, 5 points for a case where the viewing time is 1 minute or more but less than 2 minutes, 3 points for a case where the viewing time is less than 1 minute, and the like). A method of allocating scores for each item is set in advance in the setting unit 107. The score calculation unit 103 also determines the distance from the display device and the position of each person relative to the display device 20 on the basis of the position of each person in the captured image. In addition, the score calculation unit 103 detects a line of sight of the person from the captured image to determine whether the person is viewing the display device 20 and measures the viewing time.

Then, the score calculation unit 103 extracts a person whose assigned score is equal to or greater than a reference point preset in the setting unit 107 as a target person to be targeted by an advertisement. The score calculation unit 103 then associates attributes of the target person with the score and outputs them to the generation unit 104.

When the conditions for generating a reproduction schedule are satisfied (retention state), the generation unit 104 generates a reproduction schedule that determines an order and/or the number of times according to a type of content to be reproduced, on the basis of the viewing status of the plurality of persons included in the captured image. The order and/or the number of times according to the type of content to be reproduced may be any of the order according to the type of content to be reproduced, the number of times according to the type of content to be reproduced, or the order according to the type of content to be reproduced and the number of times according to the type. The type of content in the present embodiment is attributes of a person targeted by an advertisement of the content. For example, the generation unit 104 generates a reproduction schedule so that a reproduction time according to the type is distributed according to the viewing status of the plurality of persons. Specifically, the generation unit 104 generates a reproduction schedule so that a proportion (distribution) of the reproduction time of content targeted at each person is determined according to a ratio of the scores of each person. The generation unit 104 then instructs the reproduction unit 105 to perform reproduction based on the generated reproduction schedule.

In addition, when there is a change in the viewing status of at least one of the plurality of persons, the generation unit 104 generates a new reproduction schedule based on the changed viewing status, and instructs the reproduction unit 105 to perform reproduction based on the new reproduction schedule after reproduction of one piece of content currently being reproduced is completed. In addition, if the viewing status of at least one of the plurality of persons changes again within a certain period of time after it has changed, the generation unit 104 sets corresponding content to be reproduced on the display device 20 to default content set in advance and instructs the reproduction unit 105 to reproduce the default content.

The reproduction unit 105 causes the display device 20 to reproduce the content according to an instruction from the generation unit 104. Specifically, on the basis of the reproduction schedule, the reproduction unit 105 reads the content from the storage unit 106 and outputs a video signal of the read content to the display device 20, thereby causing the display device 20 to reproduce the content. In addition, when the conditions for generating the reproduction schedule are not satisfied (not in a retention state), the reproduction unit 105 causes the display device 20 to reproduce the default content.

The storage unit 106 stores various types of data for display control of the display device 20. For example, the storage unit 106 stores content of each advertisement to be displayed on the display device 20. In addition, the storage unit 106 stores in advance attributes corresponding to each content and a reproduction time of each content. Attributes corresponding to content indicate attributes of a person whom an advertisement of the content (or a product) is targeted at.

The setting unit 107 receives an input from a user and performs various settings for generating a reproduction schedule. For example, the setting unit 107 sets in advance the method of allocating scores for each item, a reference point for a score of a target person, a time per reproduction schedule (for example, 1 to 2 minutes), or the total number of times corresponding content is reproduced per reproduction schedule (for example, 6 times).

Next, processing of generating a reproduction schedule will be described in detail using a specific example. The following describes an example in which the total reproduction time per reproduction schedule set in the setting unit 107 is one minute, and a reproduction time of each content is 10 seconds. In this example, the total number of times to reproduce content is six times. First, the generation unit 104 acquires the attributes and score of the target person from the score calculation unit 103.

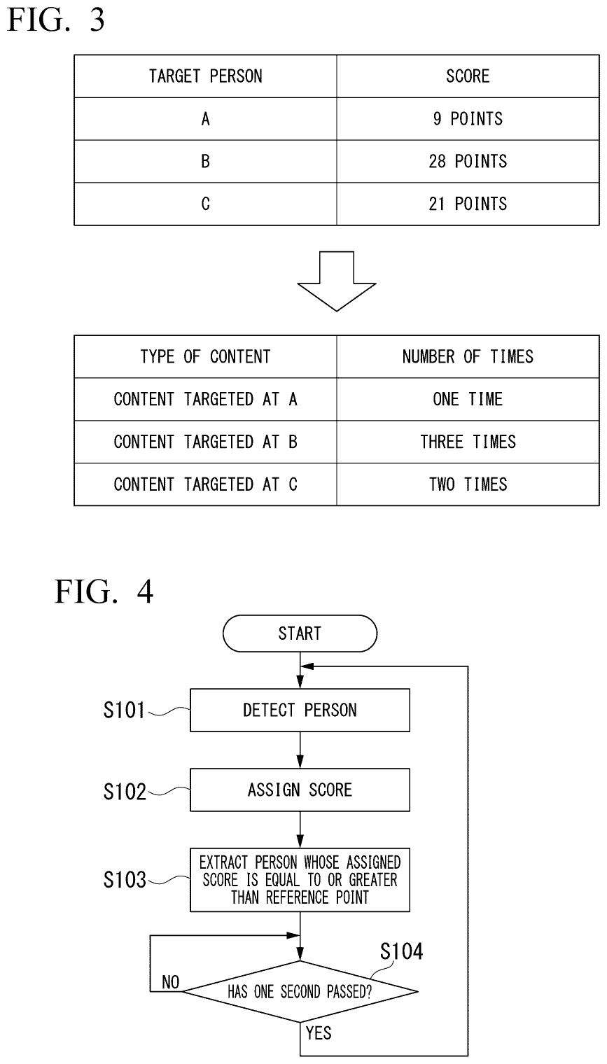

FIG. 3 is a diagram which shows an example of a reproduction schedule generated on the basis of the score of each target person in the embodiment of the present invention.

In the example shown in FIG. 3, the scores of three target persons A, B, and C are 9 points, 28 points, and 21 points, respectively. First, the generation unit 104 calculates the ratio of the scores of the target persons A, B, and C, which is 9:28:21. The ratio of the scores is not limited to this example, and may be a ratio with a minimum score set to 1, or may be a ratio with a total score of all target persons set to 1. Then, the generation unit 104 determines the number of times to reproduce content for each target person to be closest to the ratio of the scores. Content for a target person is content that corresponds to the attributes of a target person (targeted at the target person) and indicates the type of content. In this example, the generation unit 104 determines the number of times to reproduce content for a target person A to be 1 time, the number of times to reproduce content for a target person B to be 3 times, and the number of times to reproduce content for a target person C to be 2 times so that the total number of times to reproduce content is within 6 times. In this example, the reproduction times of all content included in the reproduction schedule are the same, but the reproduction times of a plurality of pieces of content included in the reproduction schedule may also be different. For example, when the total reproduction time per reproduction schedule is one minute, the generation unit 104 may include two pieces of content with a reproduction time of 15 seconds and three pieces of content with a reproduction time of seconds.

Then, the generation unit 104 determines a reproduction order of content so that the same content is not reproduced consecutively as much as possible. At this time, the generation unit 104 may determine the reproduction order so that content for a target person with a high score is reproduced before content for a target person with a low score. Then, the generation unit 104 instructs the reproduction unit 105 to perform reproduction based on the generated reproduction schedule. The reproduction unit 105 causes the display device 20 to reproduce content on the basis of the reproduction schedule generated by the generation unit 104.

As a result, the content for each of the plurality of target persons can be sequentially switched and reproduced on the display device 20. Therefore, the content can be reproduced by targeting a plurality of persons viewing the display device 20 without being biased toward only a person with specific attributes. As a result, an opportunity to view the content can be created for each of the plurality of persons viewing the display device 20. In addition, by increasing the number of times to reproduce content targeted at the person with a high score, the content targeted at a person who is highly interested in the display device 20 can be reproduced for a longer period of time, thereby improving effectiveness of advertising.

Then, when the reproduction of all the content in the reproduction schedule has been completed, and if there has been no change in the score of a target person within a certain period of time (for example, 10 seconds), the generation unit 104 generates a new reproduction schedule again and instructs the reproduction unit 105 to perform reproduction based on the new reproduction schedule. Changes in the score of a target person include an increase or decrease in the number of target persons, a replacement, and the like. This makes it possible to continue to implement effective targeted advertising when an area in front of the display device 20 continuously remains in the retention state. Targeted advertising refers to advertising targeted at a target person by reproducing content that corresponds to the attributes of the target person.

Furthermore, when there is no change in the score of the target persons within a certain period of time (for example, 10 seconds) after the score of at least one of the target persons has changed during the reproduction of one piece of content included in the generated reproduction schedule, the generation unit 104 generates a new reproduction schedule. Then, after the reproduction of one piece of content being reproduced ends, the generation unit 104 instructs the reproduction unit 105 to execute the new reproduction schedule instead of a currently executed reproduction schedule. After the reproduction of one piece of content being reproduced ends, the reproduction unit 105 causes the display device 20 to reproduce content on the basis of the new reproduction schedule.

This makes it possible to flexibly change the reproduction schedule and implement targeted advertising according to a state after the change when a person moves in front of the display device 20 and then returns to the retention state.

On the other hand, when there has been a change in the score of at least one of the target persons within a recent certain period of time, the generation unit 104 causes the display device 20 to reproduce default content via the reproduction unit 105. As a result, when a person continues to move in front of the display device 20 and an effective reproduction schedule cannot be created, the generation of a reproduction schedule (or an ongoing reproduction schedule) can be stopped and the default content set in advance can be reproduced on the display device 20.

Next, an operation of the display system 1 will be described.

FIG. 4 is a flowchart which describes the operation of score calculation processing executed by the display system in an embodiment of the present invention.

When the determination unit 102 determines that the conditions for generating a reproduction schedule are satisfied (in the retention state), the score calculation unit 103 of the information processing device 10 executes processing of steps S101 to S103 shown in FIG. 4 at a predetermined cycle (1 second in the example shown in FIG. 4).

First, the score calculation unit 103 detects persons who have remained within the viewing range for a certain period of time or more from the captured image, and analyzes the attributes of each detected person (step S101). Then, the score calculation unit 103 assigns a score to each person on the basis of the viewing status of each detected person (step S102). Specifically, the score calculation unit 103 calculates a total score of each item of the distance from the display device 20 to a person, the position of the person relative to the display device 20, and the time during which the person is viewing the display screen of the display device 20. Next, the score calculation unit 103 extracts a person whose assigned score is equal to or greater than the reference point as a target person (step S103). The score calculation unit 103 then determines whether one second has passed since a previous score has been assigned (step S104). When one second has not passed (NO in step S104), processing of step S104 is repeated. On the other hand, when one second has passed (YES in step S104), the procedure returns to processing of step S101.

In this manner, by assigning a score on the basis of the viewing status of each person, the degree of interest of each person in the display device 20 can be quantified. In addition, by extracting only persons with high scores as target persons for advertising, persons who have low interest in the display device 20 and are unlikely to view the display device 20 can be excluded from the targets. For example, persons passing in front of the display device 20 or persons far away from the display device 20 can be excluded from the targets.

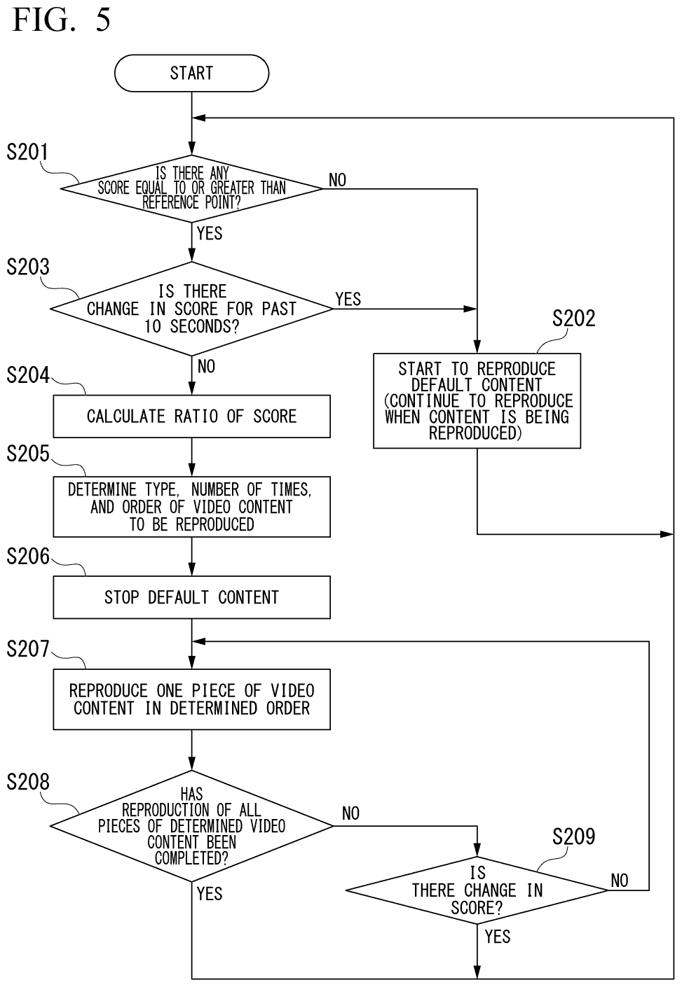

FIG. 5 is a flowchart which describes an operation of reproduction schedule generation processing executed by the display system in the embodiment of the present invention.

The generation unit 104 of the information processing device 10 executes processing shown in FIG. 5 when the determination unit 102 determines that the conditions for generating a reproduction schedule are satisfied (in the retention state).

First, the generation unit 104 acquires the score of each target person. This score is a score assigned to each target person by the score calculation unit 103 that has executed the score calculation processing described above at a timing when the score is acquired. Then, the generation unit 104 determines whether any of the acquired scores is equal to or greater than a reference score (one or more target persons have been extracted in step S103) (step S201).

When there is no score equal to or greater than the reference point (NO in step S201), the generation unit 104 outputs an instruction to the reproduction unit 105 to start reproduction of the default content if the default content is not being reproduced, and outputs an instruction to the reproduction unit 105 to continue reproducing the default content if the default content is being reproduced. The reproduction unit 105 causes the display device 20 to reproduce the default content according to an instruction from the generation unit 104 (step S202). Then, the procedure returns to processing of step S201.

On the other hand, when there is a score equal to or greater than the reference point (YES in step S201), the generation unit 104 determines whether there has been a change in the score of each target person for the past 10 seconds (step S203). For example, the generation unit 104 determines whether there has been a change in the score by comparing the scores of each target person for 10 times obtained every second for the past 10 seconds. By determining whether there has been a change in the score, it is possible to ascertain whether there has been a change in a viewing behavior of a person. When there has been a change in the score (YES in step S203), the procedure proceeds to processing of step S202.

On the other hand, when there has been no change in the score (NO in step S203), the generation unit 104 calculates the ratio of the scores of each target person (step S204). Then, on the basis of the calculated ratio and the attributes of each target person, the generation unit 104 generates a reproduction schedule that determines the type, the number of times, and the order of content to be reproduced (step S205).

Then, the generation unit 104 instructs the reproduction unit 105 to stop the default content. The reproduction unit 105 stops a reproduction of the default content in accordance with the instruction from the generation unit 104 (step S206). The reproduction of the default content may be stopped when a reproduction time of the default content being reproduced reaches an end, or the reproduction of the default content being reproduced may be stopped midway. The reproduction unit 105 then causes the display device 20 to reproduce one piece of content in order of the generated reproduction schedules (step S207).

When the reproduction of one piece of content reproduced in the order of the reproduction schedule ends, the generation unit 104 determines whether the reproduction of all pieces of content included in the reproduction schedule has been completed (step S208). When the reproduction of all pieces of content has been completed (YES in step S208), the generation unit 104 returns the procedure to the processing of step S201.

On the other hand, when the reproduction of all the content has not been completed, that is, when there is content remaining in the reproduction schedule (NO in step S208), the generation unit 104 acquires the score of each target person from the score calculation unit 103 and compares it with the score used when the ratio in step S204 is calculated to determine whether there is a change in the score of each target person since the ratio has been calculated (step S209). When there is no change in the score (NO in step S209), the generation unit 104 returns to processing of step S207 and causes the display device 20 to reproduce a next piece of content included in the reproduction schedule. On the other hand, when there is a change in the score (YES in step S209), the generation unit 104 returns to the processing of step S201.

Note that a certain period of time for the determination unit 102 to determine whether to generate an initial reproduction schedule (to determine whether the conditions for generating a reproduction schedule are satisfied) and a certain period of time for the generation unit 104 to determine whether to continue generating a reproduction schedule in step S203 may be the same or different. For example, the certain period of time for determining whether to generate an initial reproduction schedule (for example, 30 seconds to 2 minutes) may be set longer than the certain period of time for determining whether to continue generating a reproduction schedule (for example, 10 seconds). These certain periods of time are time during which it can be determined that there is no movement of a person.

In this manner, the display system 1 according to the present embodiment has the generation unit 104 that generates a reproduction schedule that determines the order and/or the number of times according to the type of content to be reproduced on the basis of the viewing status of the plurality of persons included in the captured image obtained by capturing an area where the display screen of the display device 20 is visible, and the display device 20 that reproduces content on the basis of the reproduction schedule.

With such a configuration, it is possible to sequentially reproduce content targeting each of the plurality of persons viewing the display device 20. Therefore, it is possible to efficiently switch between target persons and reproduce content effectively without being biased towards a specific person.

In addition, the generation unit 104 generates a reproduction schedule so that the reproduction time according to the type is allocated according to the viewing status of the plurality of persons. With such a configuration, it is possible to preferentially reproduce content for a person who is more interested in the display device 20.

The generation unit 104 also generates a reproduction schedule when a plurality of persons are detected from the captured image and the positions of the detected persons do not change for a certain period of time. This makes it possible to generate a reproduction schedule when the plurality of persons remain in front of the display device (an imaging area A). When the plurality of persons remain in front of the display device 20, it can be said that content displayed on the display device 20 is in a state where the persons easily view. Therefore, in a state where the persons remain, it is possible to reproduce content according to that retention state by generating a reproduction schedule.

Here, the certain period of time may be any period of time during which a person is not moving, and may be determined arbitrarily to, for example, 5 seconds, 10 seconds, or the like.

Moreover, when there is a change in the viewing status of at least one of the plurality of persons, the generation unit 104 generates a new reproduction schedule based on the changed viewing status. With such a configuration, it is possible to flexibly change the reproduction schedule in accordance with the change in the viewing status and reproduce effective content according to the changed state.

Moreover, when there is another change within a certain period of time after the viewing status of at least one of the plurality of persons has changed, the generation unit 104 sets content to be reproduced on the display device 20 to the default content. With such a configuration, when a person continues to move in front of the display device 20 and an effective reproduction schedule cannot be created, it is possible to reproduce the default content without generating a reproduction schedule.

The viewing status is at least one of the distance from the display device 20 to a person, the position of the person relative to the display device, and the time during which the person is viewing the display screen. With such a configuration, the degree of interest of each person in the display device 20 can be accurately determined based on the viewing status.

The display system 1 further includes the score calculation unit 103 that calculates the score for each of the plurality of persons on the basis of the viewing status, and the generation unit 104 generates a reproduction schedule such that content targeted at each person is reproduced in the ratio of the scores of each person. With such a configuration, the degree of interest of each of the plurality of persons in the display device 20 can be calculated by the score, and a reproduction schedule can be generated in which content targeted at each person is reproduced in the ratio of the scores. This makes it possible to preferentially reproduce content targeted at a person with a high degree of interest in the display device 20.

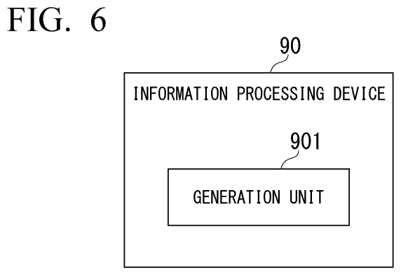

FIG. 6 shows an example of a configuration of another aspect of the information processing device of the present invention.

An information processing device 90 shown in FIG. 6 has a generation unit 901.

The generation unit 901 generates a reproduction schedule that determines the order and/or the number of times according to the type of content to be reproduced, on the basis of the viewing status of a plurality of persons included in a captured image obtained by capturing an area where a display screen of a display device is visible.

In addition, a program for realizing each function of the information processing device in FIG. 2 may be recorded on a computer-readable recording medium, and the program recorded on the recording medium may be read into a computer system and executed to perform position detection. Note that a term “computer system” herein includes the OS and hardware such as peripheral devices.

In addition, when a WWW system is used, the “computer system” also includes a homepage provision environment (or display environment).

Furthermore, a “computer-readable recording medium” refers to portable medium such as a flexible disk, an optical magnetic disc, a ROM, or a CD-ROM, as well as a storage device such as a hard disk embedded into a computer system. Furthermore, a “computer-readable recording medium” includes those that hold a program for a certain period of time, such as volatile memory inside a computer system that serves as a server or client. The program described above may be for implementing part of the functions described above, or may be capable of implementing the functions described above in combination with a program already recorded in the computer system. The program described above may be stored in a specified server, and distributed (downloaded, or the like) via a communication line in response to a request from another device.

The embodiment of the present invention has been described above in detail with reference to the drawings, but the specific configuration is not limited to this embodiment, and designs within a scope of the gist of the present invention are also included.

### REFERENCE SIGNS LIST

1 Display system
10, 90 Information processing device
101 Captured image acquisition unit
102 Determination unit
103 Score calculation unit
104, 901 Generation unit
105 Reproduction unit
106 Storage unit
107 Setting unit
20 Display device
30 Imaging device

1. An information processing device comprising:
a generation unit configured to generate a reproduction schedule that determines an order and/or the number of times according to a type of content to be reproduced, on the basis of a viewing status of a plurality of persons included in a captured image obtained by capturing an area where a display screen of a display device is visible.

2. The information processing device according to claim 1,
wherein the generation unit generates the reproduction schedule so that reproduction times according to the types are distributed according to the viewing status of the plurality of persons.

3. The information processing device according to claim 1,
wherein the generation unit generates the reproduction schedule when it is determined that the viewing status of the plurality of persons detected from the captured image has not changed for a certain period of time.

4. The information processing device according to claim 1,
wherein, when the viewing status of at least one of the plurality of persons changes, the generation unit generates a new reproduction schedule based on the changed viewing status.

5. The information processing device according to claim 1,
wherein, when the viewing status of at least one of the plurality of persons changes again within a certain period of time after the viewing status has changed, the generation unit sets content reproduced by the display device as default content.

6. The information processing device according to claim 1,
wherein the viewing status is at least one of a distance from the display device to a person, a position of the person relative to the display device, and time during which the person is viewing the display screen.

7. The information processing device according to claim 1, further comprising:
a score calculation unit configured to calculate a score of each of the plurality of persons on the basis of the viewing status,
wherein the generation unit generates the reproduction schedule so that content targeted at each of the persons is reproduced according to a ratio of the scores of each person.

8. A display system comprising:
a generation unit configured to generate a reproduction schedule that determines an order and/or the number of times according to a type of content to be reproduced, on the basis of a viewing status of a plurality of persons included in a captured image obtained by capturing an area where a display screen of a display device is visible; and
a display device configured to reproduce content on the basis of the reproduction schedule.

9. An information processing method comprising:
generating, by a computer, a reproduction schedule that determines an order and/or the number of times according to a type of content to be reproduced, on the basis of a viewing status of a plurality of persons included in a captured image obtained by capturing an area where a display screen of a display device is visible.
